(19) United States
(12) Patent Application Publication
(10) Pub. No.: US 2023/0116572 A1
(43) Pub. Date: Apr. 13, 2023

(54) AUTONOMOUS VEHICLE, SYSTEM FOR REMOTELY CONTROLLING THE SAME, AND METHOD THEREOF

(71) Applicants: Hyundai Motor Company, Seoul (KR); Kia Corporation, Seoul (KR)

(72) Inventor: Kyung Joo Bang, Seoul (KR)

(21) Appl. No.: 17/832,978

(22) Filed: Jun. 6, 2022

(30) Foreign Application Priority Data
Oct. 13, 2021 (KR) 10-2021-0136077

(51) Int. Cl. B60W 60/00

(52) U.S. Cl. CPC B60W 60/0025; B60W 60/0015; B60W 2300/10; B60W 2520/04; B60W 2420/42; B60W 2540/041; B60W 2556/45

(57) ABSTRACT

The present disclosure relates to an autonomous vehicle, a system for remotely controlling the same, and a method thereof. An exemplary embodiment of the present disclosure provides an autonomous vehicle, including: an autonomous driving control apparatus configured to include a communication device configured to communicate with a control system; and a processor that automatically determines whether door opening or closing and re-start are required in a situation that occupants get on or off the autonomous vehicle, and when an operation depending on an automatic determination result thereof is impossible or the automatic determination is impossible, and requests remote control to the control system through the communication device.

### CROSS-REFERENCE TO RELATED APPLICATION

This application is based on and claims benefits of Korean Patent Application No. 10-2021-0136077, filed in the Korean Intellectual Property Office on Oct. 13, 2021, the entire contents of which are incorporated herein by reference.

### TECHNICAL FIELD

The present disclosure relates to an autonomous vehicle, a system for remotely controlling the same, and a method thereof, and more particularly, to a technique for remotely controlling door opening or closing and re-start when an occupant gets on or(and) off the autonomous vehicle.

### DESCRIPTION OF THE RELATED ART

As an electronic technique of a vehicle develops, an interest in an autonomous vehicle (including an autonomous bus) that drives to a destination by recognizing a driving environment of the vehicle itself without manipulation of a driver has been growing.

An autonomous vehicle (e.g., bus) refers to a vehicle capable of operating by itself without manipulation of a driver or a passenger.

Conventionally, after getting on or off the autonomous bus, a control manager may be remotely requested to check a number of occupants in the vehicle, or before re-starting, it may be requested to check whether the occupants are wearing a seat belt and a door is closed in order to ensure that the occupants properly get on or off. That is, in the conventional autonomous bus, an occupant directly opens and closes the door for getting on or off, and the control manager may only perform a role of confirming the result afterwards. However, in the case of the autonomous bus, the autonomous vehicle must automatically determine whether to open or close the door, and an unspecified number of occupants get on or off without prior information, and thus it is impossible to know whether occupants are getting on or off normally just by checking the number of occupants in the bus after getting on or off the bus at a stop (e.g., bus stop).

Further, since the autonomous bus do not have seat belts or may be driven while occupants are in a standing position therein, safe re-start may not be guaranteed by checking whether seat belts are worn. In addition, the autonomous bus need to consider not only an interior of the vehicle, but also a condition of a space between a vehicle and a stop (e.g., bus stop).

The above information disclosed in this Background section is only for enhancement of understanding of the background of the disclosure, and therefore, it may contain information that does not form the prior art that is already known in this country to a person of ordinary skill in the art.

### SUMMARY

An exemplary embodiment of the present disclosure have been made in an effort to provide an autonomous vehicle, a system for remotely controlling the same, and a method thereof, capable of automatically determining door opening or closing and re-starting in an occupant getting on or off situation of an autonomous bus, and when it is difficult or impossible to automatically determine the automatically determined result, performing the door opening or closing and the re-starting through remote control.

The technical objects of the present disclosure are not limited to the objects mentioned above, and other technical objects not mentioned can be clearly understood by those skilled in the art from the description of the claims.

An exemplary embodiment of the present disclosure provides an autonomous vehicle, including: an autonomous driving control apparatus configured to include a communication device configured to communicate with a control system; and a processor that automatically determines whether door opening or closing and re-start are required in a situation that occupants get on or off the autonomous vehicle, and when an operation depending on an automatic determination result thereof is impossible or the automatic determination is impossible, and requests remote control to the control system through the communication device.

In an exemplary embodiment, the processor may be configured to determine whether a door needs to be opened based on surrounding situation information when the autonomous vehicle arrives at a stop (e.g., bus stop).

In an exemplary embodiment, the processor may be configured to determine whether a door needs to be closed when occupants completely get on or off the autonomous vehicle after a door of the autonomous vehicle is opened based on vehicle interior information.

In an exemplary embodiment, the processor may be configured to determine whether the autonomous vehicle needs to be re-started when an occupant is seated based on vehicle interior information of the autonomous vehicle after a door of the autonomous vehicle is closed.

In an exemplary embodiment, the processor may be configured to request remote control for door opening to the control system when a state in which it is impossible to perform the door opening continues for more than a predetermined time or a state in which it is impossible to determine whether a door opening control is possible continues for more than a predetermined time in a situation where the autonomous vehicle stops at a stop (e.g., bus stop) and the door needs to be opened.

In an exemplary embodiment, the processor may be configured to request remote control for door closing to the control system when a state in which it is impossible to perform the door closing continues for more than a predetermined time or a state in which it is impossible to determine whether a door closing control is possible continues for more than a predetermined time in a situation where the autonomous vehicle stops at a stop (e.g., bus stop), the door is opened, and then the door needs to be closed.

In an exemplary embodiment, the processor may be configured to request remote control for re-start to the control system when a state in which it is impossible to perform the re-starting control is possible continues for more than a predetermined time or a state in which it is impossible to determine the re-starting control is possible continues for more than a predetermined time in a situation where the autonomous vehicle stops at a stop (e.g., bus stop) and requires the re-start after an occupant completes getting on or off and the door is closed.

In an exemplary embodiment, the processor may be configured to transmit vehicle interior image data and interior audio data to the control system when a door opening remote control request is required because a situation in which occupants or goods exist within the autonomous vehicle continues or in the case where the door opening remote control request is required when door jamming is detected during door opening control.

In an exemplary embodiment, the processor may be configured to transmit vehicle exterior image data and exterior object detection information to the control system when a situation where there is an obstacle in a space between a door and a stop (e.g., bus stop) of the autonomous vehicle continues and a door opening remote control request is required or when a situation where a moving object approaches the space between the door and the stop (e.g., bus stop) of the autonomous vehicle continues and the door opening remote control request is required.

In an exemplary embodiment, the processor may be configured to transmit fault information and fault related video data to the control system when a remote control request is required because a situation in which information necessary for determining at least one of door opening, door closing, and re-start is not received continues for more than a predetermined time.

In an exemplary embodiment, the processor may be configured to transmit vehicle interior image data, vehicle exterior image data, and stop (e.g., bus stop) image data to the control system when a remote control request is required because it is impossible to determine at least one of door opening, door closing, and re-start due to unknown causes, or a standby state lasts for more than a predetermined time.

In an exemplary embodiment, the processor may be configured to transmit vehicle exterior image data and stop (e.g., bus stop) image data to the control system when a remote control request is performed in the case where a state in which it is determined that there are occupants trying to get on it around a door outside the autonomous vehicle continues for more than a predetermined time.

In an exemplary embodiment, the processor may be configured to transmit vehicle interior image data and interior audio data to the control system when a remote control request is performed in the case where a situation in which a standing occupant moves or does not hold a handle in an interior of the autonomous vehicle continues for more than a predetermined time.

In an exemplary embodiment, the processor may be configured to transmit at least one of exterior image data in a direction toward a second vehicle or object, object detection information, information related to the second vehicle to the control system when a situation where re-start is impossible due to interference from the second vehicle or object continues for more than a predetermined time.

An exemplary embodiment of the present disclosure provides a system including: a communication device configured to communicate with an autonomous vehicle; and a processor configured to transmit a remote control command to the autonomous vehicle based on information received from the autonomous vehicle when a remote control request of at least one of door opening, door closing, and re-start is received from the autonomous vehicle through the communication device.

In an exemplary embodiment, the processor may be configured to process a plurality of remote control requests in a chronological order or depending on a predetermined priority when the remote control requests are received from the autonomous vehicle.

In an exemplary embodiment, the processor may be configured to preferentially process a remote control request related to a safety accident, a remote control request by a vehicle that prevents re-start of another vehicle, a remote control request due to failure or unknown cause.

In an exemplary embodiment, it may further include a stop (e.g., bus stop) monitoring device configured to acquire stop (e.g., bus stop) surrounding image data and to provide it to the control system.

An exemplary embodiment of the present disclosure provides a remote control method including: automatically determining whether door opening or closing and re-start are required in a situation that occupants get on or off the autonomous vehicle; and requesting remote control to a control system when an operation depending on an automatic determination result thereof is impossible or the automatic determination is impossible.

In an exemplary embodiment, the automatically determining may include: determining whether a door needs to be opened based on surrounding situation information when the autonomous vehicle arrives at a stop (e.g., bus stop); determining whether the door needs to be closed when occupants completely get on or off the autonomous vehicle after the door of the autonomous vehicle is opened based on vehicle interior information; and may determine whether the autonomous vehicle needs to be re-started when an occupant is seated based on vehicle interior information of the autonomous vehicle after a door of the autonomous vehicle is closed.

According to the present technique, it is possible to improve safety of occupants by automatically determining door opening or closing and re-starting in an occupant getting on or off situation of an autonomous bus, and when it is difficult or impossible to automatically determine the automatically determined result, performing the door opening or closing and the re-start through remote control.

In addition, various effects that can be directly or indirectly identified through this document may be provided.

As discussed, the method and apparatus suitably include use of a controller or processer.

In another aspect, vehicles are provided that comprise an apparatus as disclosed herein.

In a fully autonomous vehicle or system, the vehicle may perform all driving tasks under all conditions and little or no driving assistance is required a human driver. In a semi-autonomous vehicle, for example, the automated driving system may perform some or all parts of the driving task in some conditions, but a human driver regains control under some conditions, or in other semi-autonomous systems, the vehicle's automated system may oversee steering and accelerating and braking in some conditions, although the human driver is required to continue paying attention to the driving environment throughout the journey, while also performing the remainder of the necessary tasks.

In certain aspects, the present apparatus, systems and vehicles may be fully autonomous. In other certain aspects, the present apparatus, systems and vehicles may be semi-autonomous.

### BRIEF DESCRIPTION OF THE DRAWINGS

FIG. 1 illustrates a block diagram showing a configuration of an autonomous vehicle (including an autonomous bus) control apparatus and a control system according to an exemplary embodiment of the present disclosure.

FIG. 2 illustrates a data flow inside an autonomous bus control apparatus according to an exemplary embodiment of the present disclosure.

FIG. 3 illustrates a flowchart showing a remote control method for an autonomous bus according to an exemplary embodiment of the present disclosure.

FIG. 4 illustrates a computing system according to an exemplary embodiment of the present disclosure.

### DETAILED DESCRIPTION OF THE EMBODIMENTS

It is understood that the term “vehicle” or “vehicular” or other similar term as used herein is inclusive of motor vehicles in general and includes vehicles with internal combustion engines as well as electric vehicles and other alternative fuel vehicles (e.g., fuels derived from resources other than petroleum).

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation and can be implemented by hardware components or software components and combinations thereof.

Further, the control logic of embodiments of the present disclosure may be embodied as non-transitory computer readable media on a computer readable medium containing executable program instructions executed by a processor, controller, or the like. Examples of computer readable media include, but are not limited to, ROM, RAM, compact disc (CD)-ROMs, magnetic tapes, floppy disks, flash drives, smart cards, and optical data storage devices. The computer readable medium can also be distributed in network coupled computer systems so that the computer readable media is stored and executed in a distributed fashion, e.g., by a telematics server or a Controller Area Network (CAN).

Hereinafter, some exemplary embodiments of the present disclosure will be described in detail with reference to exemplary drawings. It should be noted that in adding reference numerals to constituent elements of each drawing, the same constituent elements have the same reference numerals as possible even though they are indicated on different drawings. In addition, in describing exemplary embodiments of the present disclosure, when it is determined that detailed descriptions of related well-known configurations or functions interfere with understanding of the exemplary embodiments of the present disclosure, the detailed descriptions thereof will be omitted.

In describing constituent elements according to an exemplary embodiment of the present disclosure, terms such as first, second, A, B, (a), and (b) may be used. These terms are only for distinguishing the constituent elements from other constituent elements, and the nature, sequences, or orders of the constituent elements are not limited by the terms. In addition, all terms used herein including technical scientific terms have the same meanings as those which are generally understood by those skilled in the technical field to which the present disclosure pertains (those skilled in the art) unless they are differently defined. Terms defined in a generally used dictionary shall be construed to have meanings matching those in the context of a related art and shall not be construed to have idealized or excessively formal meanings unless they are clearly defined in the present specification.

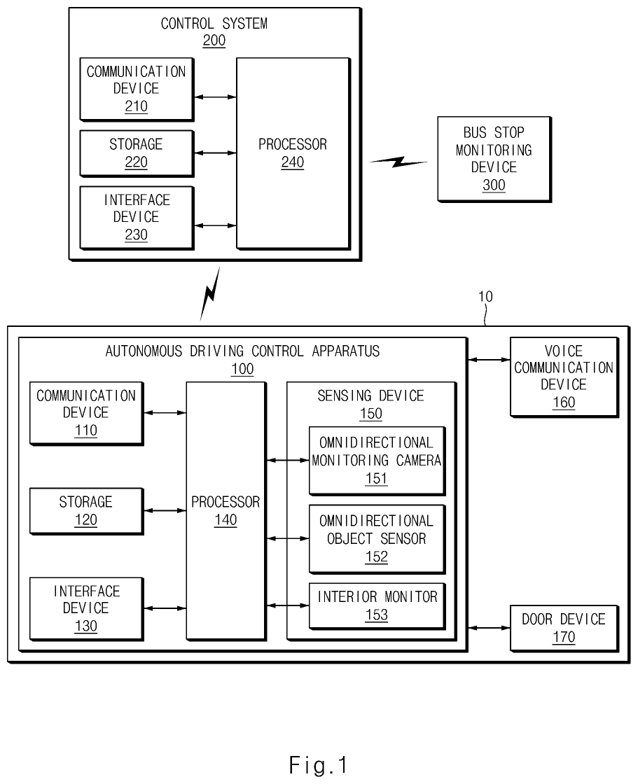

Hereinafter, exemplary embodiments of the present disclosure will be described in detail with reference to FIG. 1 to FIG. 4.

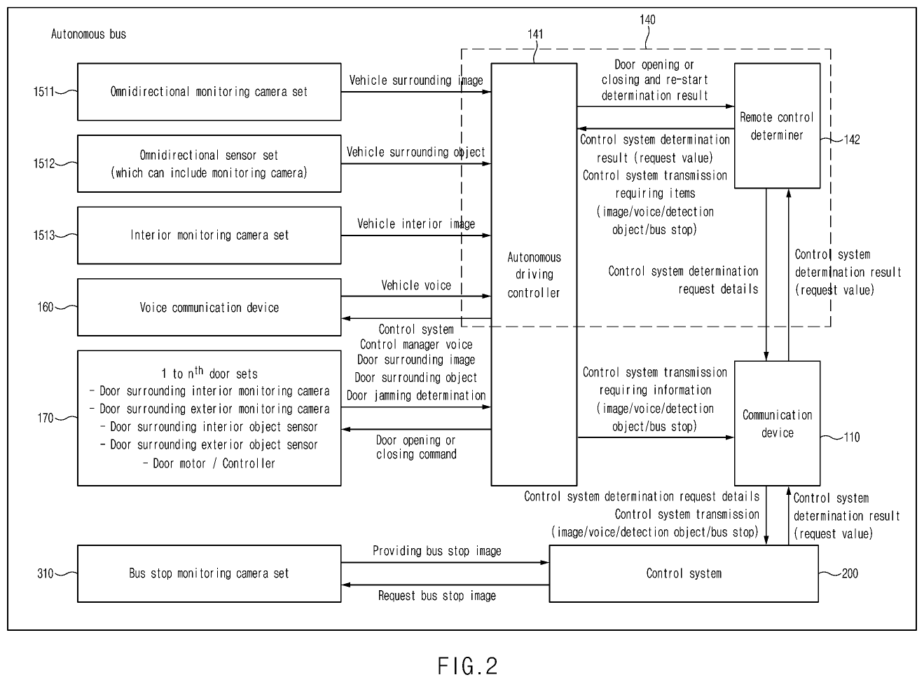

FIG. 1 illustrates a block diagram showing a configuration of an autonomous vehicle (including an autonomous bus) control apparatus and a control system according to an exemplary embodiment of the present disclosure, and FIG. 2 illustrates a data flow inside an autonomous bus control apparatus according to an exemplary embodiment of the present disclosure.

Referring to FIG. 1, the autonomous vehicle (including an autonomous bus) 10 may include the autonomous driving control apparatus 100 and may be subjected to remote control through communication with an external control system 200.

The autonomous driving control apparatus 100 according to the exemplary embodiment of the present disclosure may be implemented inside the vehicle. In this case, the autonomous driving control apparatus 100 may be integrally formed with internal control units of the vehicle or may be implemented as a separate device to be connected to control units of the vehicle by a separate connection means.

In order for the autonomous bus to arrive at a stop (e.g., bus stop) and to re-start after occupants get on or off, the autonomous driving control apparatus 100 performs door opening determination, door closing determination, and re-start determination. When it is impossible to perform the door opening determination, the door closing determination, and the re-start determination due to an external situation in which the autonomous bus cannot be controlled, or technical limitations, breakdowns, errors, etc. of the autonomous bus, or when it needs to stay on standby for a long time, the autonomous driving control apparatus 100 may request a situation check of a control manager or remote control to the control system 200. In this case, the autonomous driving control apparatus 100 may transmit information related to remote control to the control system 200 and may recognize external and internal conditions of the autonomous bus based on information received by the control manager to transmit a remote control command to the autonomous driving control apparatus 100.

In addition, since several autonomous buses travel through several stop (e.g., bus stop)s, the control system 200 may receive several remote control requests at the same time. In this case, the control system 200 may perform a function of giving priority to multiple remote control requests or selecting and providing information appropriate to situations for individual remote control requests such that the control manager can efficiently perform remote control.

Referring to FIG. 1, the autonomous driving control apparatus 100 may include a communication device 110, a storage 120, an interface device 130, a processor 140, and a sensing device 150.

The communication device 110 is a hardware device implemented with various electronic circuits to transmit and receive signals through a wireless or wired connection and may transmit and receive information based on in-vehicle devices and in-vehicle network communication techniques. As an example, the in-vehicle network communication techniques may include controller area network (CAN) communication, local interconnect network (LIN) communication, flex-ray communication, or the like. In addition, the communication device 110 performs communication with the external control system 200 based on wireless communication techniques. Herein, the wireless communication technique may include wireless LAN (WLAN), wireless broadband (Wibro), Wi-Fi, world Interoperability for microwave access (Wimax), etc.

For example, the communication device 110 may communicate with a communication device 210 of the control system 200. That is, the communication device 110 may transmit a remote control request, vehicle exterior image data, vehicle interior image data, vehicle interior audio data, vehicle exterior object detection information, fixation-related information, failure-related image data, etc. to the control system 200.

The storage 120 may store sensing results of the sensing device 150 and data and/or algorithms required for the processor 140 to operate, or the like. As an example, the storage 120 may store a vehicle path, image data photographed through a camera, or the like.

The storage 120 may include a storage medium of at least one type among memories of types such as a flash memory, a hard disk, a micro, a card (e.g., a secure digital (SD) card or an extreme digital (XD) card), a random access memory (RAM), a static RAM (SRAM), a read-only memory (ROM), a programmable ROM (PROM), an electrically erasable PROM (EEPROM), a magnetic memory (MRAM), a magnetic disk, and an optical disk.

The interface device 130 may include an input means for receiving a control command from a user and an output means for outputting an operation state of the apparatus 100 and results thereof. Herein, the input means may include a key button, and may further include a mouse, a keyboard, a touch screen, a microphone, a joystick, a jog shuttle, a stylus pen, or the like. In addition, the input means may further include a soft key implemented on the display.

The interface device 130 may be implemented as a head-up display (HUD), a cluster, an audio video navigation (AVN), a human machine interface (HM), a user setting menu (USM), or the like.

The output means may include a display and may further include a voice output means such as a speaker. In this case, when a touch sensor formed of a touch film, a touch sheet, or a touch pad is provided on the display, the display may operate as a touch screen, and may be implemented in a form in which an input device and an output device are integrated.

In this case, the display may include at least one of a liquid crystal display (LCD), a thin film transistor liquid crystal display (TFT LCD), an organic light emitting diode display (OLED display), a flexible display, a field emission display (FED), and a 3D display.

For example, the interface device 130 may display data transmitted and received with respect to the control system 200, a driving path of the vehicle, a state of a door of an autonomous bus, or the like.

The processor 140 may be electrically connected to the communication device 110, the storage 120, the interface device 130, the sensing device 150, or the like, may electrically control each component, and may be an electrical circuit that executes software commands, thereby performing various data processing and calculations described below.

The processor 140 may process a signal transferred between components of the autonomous driving control apparatus 100 and may perform overall control such that each of the components can perform its function normally.

The processor 140 may be implemented in the form of hardware, software, or a combination of hardware and software, or may be implemented as microprocessor, and may be, e.g., an electronic control unit (ECU), a micro controller unit (MCU), or other subcontrollers mounted in the vehicle.

The processor 140 may automatically determine whether a door needs to be opened or closed (the door needs to be opened, the door needs to be closed) and whether it is necessary to re-start it in a situation that occupants get on or off the autonomous bus, and when an operation depending on an automatic determination result thereof is impossible or the automatic determination is impossible, may request remote control to the control system 200 through the communication device.

When the autonomous bus 10 arrives at the stop (e.g., bus stop), the processor 140 may determine whether the door needs to be opened based on surrounding situation information. For example, the processor 140 may determine whether the door is open in the case where surrounding conditions are safe when the autonomous bus 10 is stopped at a stop (e.g., bus stop).

The processor 140 may determine whether the door needs to be closed when the occupants completely get on or off the autonomous bus after the door of the autonomous bus is opened based on the vehicle interior information. That is, the processor 140 may determine whether the door needs to be closed when all occupants getting on or off is completed.

The processor 140 may determine whether the autonomous bus 10 needs to be re-started when an occupant is seated or safely standing (holding a handle, etc.) based on the vehicle interior information of the autonomous bus 10 after the door of the autonomous bus 10 is closed.

The processor 140 may request remote control to the control system 200 when a state in which door opening cannot be performed continues for more than a predetermined time or a state in which it cannot be determined whether the door opening control is possible continues for more than a predetermined time in a situation where the autonomous bus 10 stops at a stop (e.g., bus stop) and the door needs to be opened.

In addition, when a remote control request is required in a situation where the door of the autonomous bus 10 needs to be opened, the processor 140 may help the control manager in determining it by transmitting necessary information to the control system 200 depending on the corresponding situation.

The processor 140 may transmit the vehicle interior image data (around the door device) and the interior voice data to the control system 200 when a door opening remote control request is required because a situation in which occupants or goods exist continues after a door opening operation. In this case, the vehicle interior image data may be acquired from an interior monitor 153 and a camera in a door device 170.

The processor 140 may transmit the vehicle exterior image data and the object detection information to the control system 200 when a situation where there is an obstacle in the space between the door and the stop (e.g., bus stop) of the autonomous bus 10 continues and a door opening remote control request is required during the door opening operation. The vehicle external image data may be obtained from an omnidirectional monitoring camera 151, and the object detection information may be obtained from an omnidirectional object sensor 152.

The processor 140 may transmit the vehicle exterior image data and the object detection information to the control system 200 when a situation where a moving object approaches a space between the door and the stop (e.g., bus stop) of the autonomous bus 10 continues and a door opening remote control request is required during the door opening operation.

The processor 140 may transmit the vehicle interior image data and the interior voice data to the control system 200 in the case where the door opening remote control request is required when door jamming is detected during door opening control.

The processor 140 may transmit fault-related information and a camera image for monitoring an area covered by a fault system to the control system 200 when a situation where some or all of information necessary to determine whether the door is opened is not received (e.g., sensor occlusion, system failure, communication error, etc.) continues and the door opening remote control request is required.

The processor 140 may transmit the vehicle interior data, the vehicle exterior image data, and stop (e.g., bus stop) image data to the control system 200 when it is impossible to determine whether the door is open due to other unknown causes or when a standby state continues and the door opening remote control request is required. When the autonomous bus 10 arrives at a stop (e.g., bus stop), the stop (e.g., bus stop) image data may be received from a stop (e.g., bus stop) monitoring device 300.

The processor 140 may request remote control to the control system 200 when a state in which door closing cannot be performed continues for more than a predetermined time or when a state in which it cannot be determined that the door closing control is possible continues for more than a predetermined time in a situation where the autonomous bus 10 stops at a stop (e.g., bus stop), opens the door, and the door needs to be closed after an occupant completes getting on or off.

When a remote control request is required in a situation where door closing is required, the processor 140 may help the control manager in determining it by providing information that is suitable for each situation to the control system 200.

The processor 140 may transmit the vehicle interior image (around the door) data and the interior audio data to the control system 200 when a situation where occupants or goods exist near the door of the autonomous bus 10 continues after the door is opened and closed.

The processor 140 may transmit a vehicle external image and a stop image to the control system 200 for a remote control request when a condition in which it is determined that there are occupants trying to board remain around the door outside of the bus continues after the door is opened and closed.

The processor 140 may transmit the vehicle interior image data and the interior voice data to the control system 200 for a remote control request when door jamming is detected during door closing control.

When a situation in which some or all of information that is necessary for determining whether the door is closed (e.g., sensor occlusion, system failure, communication error, etc.) continues, the processor 140 may transmit failure information and a camera image for monitoring an area covered by a fault system to the control system 200.

The processor 140 may transmit vehicle interior image data, vehicle exterior image data, and a stop (e.g., bus stop) image to the control system 200 when it is impossible to determine whether the door is closed due to other unknown causes or a standby state continues.

The processor 140 may request remote control to the control system 200 when a condition in which re-start cannot be performed continues for more than a predetermined time or when a condition in which re-start cannot be determined continues for more than a predetermined time in a situation where the autonomous bus 10 stops at a stop (e.g., bus stop) and requires re-start after an occupant completes getting on or off and the door is closed.

When a remote control request is required in a situation where re-start is required, the processor 140 may help the control manager in determining it by providing information that is suitable for each situation to the control system 200.

The processor 140 may transmit vehicle interior image data (standing space) and interior audio data to the control system 200 when a situation where an interiorly standing occupant moves or does not hold a handle continues in a situation requiring re-start. Accordingly, the control system 200 may determine a vehicle interior condition and, when it is determined that the occupant is in a safe state, remotely transmits a re-start command to the autonomous bus 10.

The processor 140 may transmit exterior image data and object detection information in a direction of an interfering vehicle to the control system 200 in a situation where re-start is impossible due to interference from other vehicles continues in a situation in which re-start is required. In addition, when an interfering vehicle is controlled by the same control system 200, the processor 140 may also transmit information related to the interfering vehicle to the control system 200.

The processor 140 may transmit exterior image data, object detection information, a stop (e.g., bus stop) image, or the like in the direction of the interfering object to the control system 200 in a situation where re-start is impossible due to interference from a non-vehicle object continues in a situation in which re-start is required.

When a situation in which some or all of information that is necessary for determining re-start (e.g., sensor occlusion, system failure, communication error, etc.) continues, the processor 140 may transmit failure information and a camera image for monitoring an area covered by a fault system to the control system 200.

The processor 140 may transmit vehicle interior image data, vehicle exterior image data, and a stop (e.g., bus stop) image to the control system 200 when it is impossible to determine the re-start due to other unknown causes or a standby state continues.

Referring to FIG. 2, the processor 140 may include an autonomous driving controller 141 and a remote control determiner 142. The autonomous driving controller 141 may receive a vehicle surrounding image from an omnidirectional monitoring camera set 1511, vehicle surrounding object information from a omnidirectional object detection sensor set 1512, and a vehicle interior image from an interior monitoring camera set 1513; may receive occupant voice data from a voice communication device 160 and transmit voice data of a control manager of the control system to the voice communication device 160; and may receive door surrounding image, door surrounding object information, and door jamming determination information from a door set (door device 170) and transmit a door opening/closing command signal to the door set 170.

The autonomous driving controller 141 may perform door opening or closing and re-start determination, transmits a determination result thereof to the remote control determiner 142, and receives the determination result received from the control system 200 and transmission requiring items from the remote control determiner 142.

The remote control determiner 142 may transmit a determination request details of the control system to the control system 200 through the communication device 110 and may receive a determination result thereof from the control system 200. In addition, the autonomous driving controller 141 may transmit necessary information to be transmitted to the control system to the control system 200 through the communication device 110.

The sensing device 150 may sense surroundings of the vehicle and interiors of a vehicle. To this end, the sensing device 150 may include the omnidirectional monitoring camera 151, the omnidirectional object sensor 152, and the interior monitor 153.

The omnidirectional monitoring camera 151 may capture images around the vehicle and transmits exterior image data to the processor 140. At least one omnidirectional monitoring camera 151 may be provided.

The omnidirectional object sensor 152 may sense an object around the vehicle and transmits it to the processor 140. The omnidirectional object sensor 152 may include a plurality of sensors to sense an external object of the vehicle, to obtain information related to a position of the external object, a speed of the external object, a moving direction of the external object, and/or a type of the external object (e.g., vehicles, pedestrians, bicycles or motorcycles, etc.). To this end, the omnidirectional object sensor 152 may include at least one camera, and may include an ultrasonic sensor, a radar, a camera, a laser scanner, and/or a corner radar, a lidar, an acceleration sensor, a yaw rate sensor, a torque measurement sensor and/or a wheel speed sensor, a steering angle sensor, etc.

The omnidirectional object sensor 152 may include a camera for monitoring an exterior around the door, an exterior object sensor around the door, or the like.

The interior monitor 153 may capture an interior of the vehicle and transmits interior image data to the processor 140. The interior monitor 153 may include one or more cameras installed inside the vehicle. The processor 140 may determine whether or not occupants get on or off a bus, safety of occupants, etc. by using interior image data. In addition, the interior monitor 153 may include a camera for monitoring an interior around the door, an interior object sensor around the door, or the like.

The voice communication device 160 may transmit voice data of a bus occupant to the processor 140 and may output a voice of a manager received from the control system 200.

The door device 170 may include a door surrounding interior monitoring camera, a door surrounding exterior monitoring camera, a door surrounding interior object sensor, a door surrounding exterior object sensor, a door motor driven to open and close a door, and a controller for controlling the operation of the components in the door device 170. The door device 170 may provide a door surrounding image, door surrounding object information, door jamming determination information, or the like to the autonomous driving control apparatus 100.

Meanwhile, when receiving a remote control request to the autonomous bus 10, the control system 200 may determine a situation for remote control based on information received from the autonomous driving control apparatus 100 and may transmit a remote control command to the autonomous driving control apparatus 100. In this case, the remote control command may include door opening control, door closing control, re-start control, or the like.

A control manager may check a situation (e.g., getting on or off) and a path of the autonomous bus through a screen of the control system 200. In this case, the control manager is a person who is authorized to access the control system 200 and may be disposed in a place that the access to the control system 200 is possible, such as an office inside the vehicle or outside the vehicle.

Referring to FIG. 1, the control system 200 may include a communication device 210, a storage 220, an interface device 230, and a processor 240.

The communication device 210 may be a hardware device implemented with various electronic circuits to transmit and receive signals through a wireless or wired connection and may transmit and receive information based on in-vehicle devices and in-vehicle network communication techniques. As an example, the in-vehicle network communication techniques may include controller area network (CAN) communication, local interconnect network (LIN) communication, flex-ray communication, Ethernet communication, or the like.

The storage 220 may store vehicle data received from the autonomous bus 10, and data and/or algorithm required for the processor 240 to operate, or the like.

As an example, the storage 220 may store data received from the autonomous bus 10.

The storage 220 may include a storage medium of at least one type among memories of types such as a flash memory, a hard disk, a micro, a card (e.g., a secure digital (SD) card or an extreme digital (XD) card), a random access memory (RAM), a static RAM (SRAM), a read-only memory (ROM), a programmable ROM (PROM), an electrically erasable PROM (EEPROM), a magnetic memory (MRAM), a magnetic disk, and an optical disk.

The interface device 230 may include an input means for receiving a control command from a control manager and an output means for outputting an operation state of the control system 200 and results thereof. Herein, the input means may include a key button, and may further include a mouse, a keyboard, a touch screen, a microphone, a joystick, a jog shuttle, a stylus pen, or the like. In addition, the input means may further include a soft key implemented on the display.

The output means may include a display and may further include a voice output means such as a speaker. In this case, when a touch sensor formed of a touch film, a touch sheet, or a touch pad is provided on the display, the display may operate as a touch screen, and may be implemented in a form in which an input device and an output device are integrated. In this case, the display may include at least one of a liquid crystal display (LCD), a thin film transistor liquid crystal display (TFT LCD), an organic light emitting diode display (OLED display), a flexible display, a field emission display (FED), and a 3D display.

For example, the interface device 230 may display data received from the autonomous bus 10, vehicle surrounding information, vehicle interior information, or the like.

For example, the interface device 230 may include all communication terminals such as a personal computer (PC), a notebook computer, a smartphone, a tablet PC, a pad, a personal digital assistant (PDA), and a wearable device.

The processor 240 may be electrically connected to the communication device 210, the storage 220, the interface device 230, or the like, may electrically control each component, and may be an electrical circuit that executes software commands, thereby performing various data processing and calculations described below.

When there are multiple remote control requests, the processor 240 may process the remote control requests in a requested time order. In addition, the processor 240 may determine priorities depending on a predetermined priority setting method for a plurality of remote control requests to perform it.

For example, the control system 200 may preferentially remotely control a remote control request related to a safety accident, such as a remote control request due to door jamming, a remote control request by a vehicle that prevents re-start of another vehicle, a remote control request due to failure or unknown cause, etc.

A stop (e.g., bus stop) monitor 300 may acquire an image around a stop (e.g., bus stop) and provide it to the control system 200. To this end, the stop (e.g., bus stop) monitor 300 may include one or more cameras, and may be installed at the stop (e.g., bus stop).

As such, according to embodiments of the present disclosure, it is possible to enable occupants to more safely get on or off an autonomous bus and to re-start it by determining a situation requiring remote control in a situation where door opening or closing of the autonomous bus is automatically determined, and when the remote control is required, by providing information necessary to determine the situation to the control system 200 to allow the control system to control the opening and closing of the door and the re-start through remote control, thereby enabling occupants to get on or off the autonomous bus and it to re-start more safely.

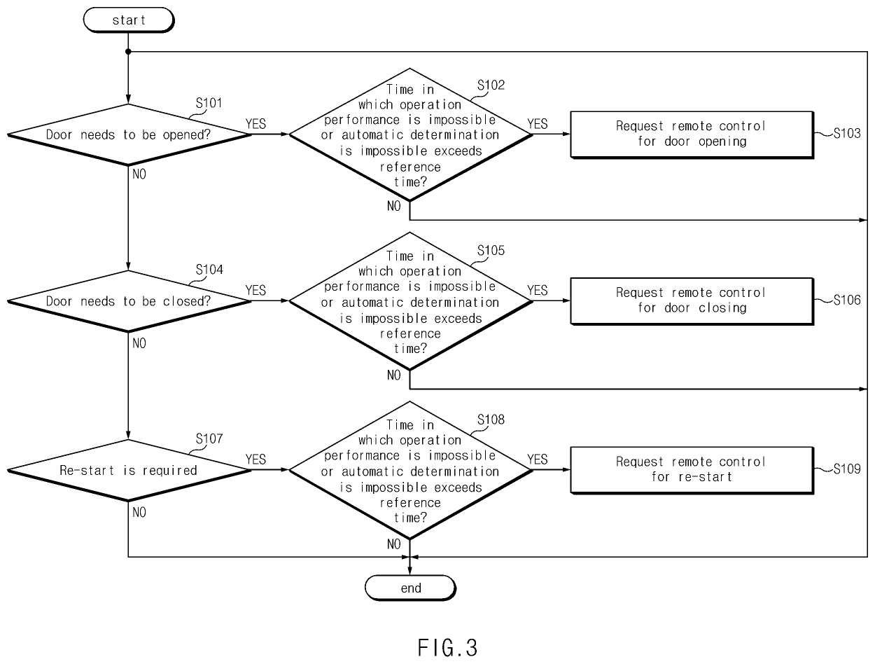

Hereinafter, a remote control method for an autonomous bus according to an exemplary embodiment of the present disclosure will be described in detail with reference to FIG. 3. FIG. 3 illustrates a flowchart showing a remote control method for an autonomous bus according to an exemplary embodiment of the present disclosure.

Hereinafter, it is assumed that the autonomous driving control apparatus 100 of the of FIG. 1 may perform processes of FIG. 3. In addition, in the description of FIG. 3, it may be understood that operations described as being performed by each device may be controlled by a processor of each of the devices.

Referring to FIG. 3, the autonomous driving control apparatus 100 may determine whether a door needs to be opened (S101). The autonomous driving control apparatus 100 may determine whether the door needs to be opened when the autonomous bus 10 arrives at a stop (e.g., bus stop), occupants needs to get on or off, and surrounding conditions are safe.

When the door opening is required, the autonomous driving control apparatus 100 may perform a door opening operation, and determines whether a state in which it is impossible to perform the door opening operation continues for more than a predetermined time, or whether a time in a state in which it is impossible to determine the door opening control is possible, that is, a time in a state in which automatic determination is impossible exceeds a predetermined reference time (S102).

When the state in which it is impossible to perform the door opening operation continues for more than the predetermined time, or whether the time in a state in which automatic determination is impossible exceeds the predetermined reference time, the autonomous driving control apparatus 100 requests remote control of the door opening to the control system 200 (S103). The autonomous driving control apparatus 100 may request remote control for door opening to the control system 200 when a state in which door opening cannot be performed continues for more than a predetermined time or a state in which it cannot be determined whether the door opening control is possible continues for more than a predetermined time in a situation where the autonomous stop (e.g., bus stop)s at a stop (e.g., bus stop) and the door needs to be opened.

In this case, when a remote control request is required in a situation where the door of the autonomous bus 10 needs to be opened, the autonomous driving control apparatus 100 may help the control manager in determining it by transmitting necessary information to the control system 200 depending on the corresponding situation.

When it is determined in step S101 that the door opening is not required, the autonomous driving control apparatus 100 determines whether the door closing is required (S104). That is, the autonomous driving control apparatus 100 may determine whether the door needs to be closed when all occupants getting on or off is completed.

When the door closing is required, the autonomous driving control apparatus 100 determines whether a state in which it is impossible to perform the door closing operation continues for more than a predetermined time, or a time in a state in which automatic determination of the door closing is impossible exceeds a predetermined reference time (S105).

When the state in which it is impossible to perform the door closing operation continues for more than the predetermined time, or whether the time in a state in which the automatic determination of door closing is impossible exceeds the predetermined reference time, the autonomous driving control apparatus 100 requests remote control of the door closing to the control system 200 (S106). The autonomous driving control apparatus 100 may request remote control to the control system 200 when a state in which door closing cannot be performed continues for more than a predetermined time or when a state in which it cannot be determined that the door closing control is possible continues for more than a predetermined time in a situation where the autonomous bus 10 stops at a stop (e.g., bus stop), opens the door, and the door needs to be closed after an occupant completes getting on or off. When a remote control request is required to the control system in a situation where door closing is required, the autonomous driving control apparatus 100 may help the control manager in determining it by providing information that is suitable for each situation to the control system 200.

When it is determined in step S104 that the door closing is not required, the autonomous driving control apparatus 100 determines whether the re-start is required (S107). The autonomous driving control apparatus 100 may determine whether the re-start is possible when an occupant is seated or safely standing.

When the re-start is required, the autonomous driving control apparatus 100 determines whether a re-starting operation is impossible for more than a predetermined time or whether a time during which it is impossible to automatically determine whether to re-start it exceeds a predetermined reference time (S108).

When the re-starting operation is impossible for more than the predetermined time or the time during which it is impossible to automatically determine whether to re-start it exceeds the predetermined reference time, the autonomous driving control apparatus 100 requests remote control for the re-start to the control system 200 (S109). That is, the autonomous driving control apparatus 140 may request remote control to the control system 200 when a condition in which re-start cannot be performed continues for more than a predetermined time or a state in which it is impossible to determine whether the re-starting control is possible continues for more than a predetermined time in a situation where the autonomous bus 10 stops at a stop (e.g., bus stop) and requires re-start after an occupant completes getting on or off and the door is closed. In this case, when a remote control request is required in a situation where re-start is required, the autonomous driving control apparatus 100 may help the control manager in determining it by providing information that is suitable for each situation to the control system 200.

As such, according to embodiments of the present disclosure, the autonomous bus automatically determines and controls the opening and closing of the door, in this case, when automatic control of opening and closing the door is impossible, may determine it as a situation that remote control is required and request the remote control to the control system, thereby enabling occupants to get on or off the autonomous bus and it to re-start safely.

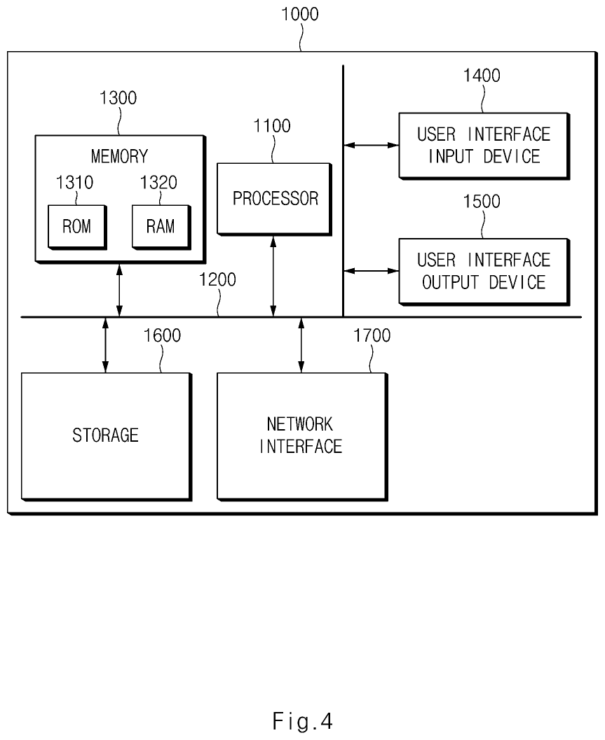

FIG. 4 illustrates a computing system according to an exemplary embodiment of the present disclosure.

Referring to FIG. 4, the computing system 1000 may include at least one processor 1100 connected through a bus 1200, a memory 1300, a user interface input device 1400, a user interface output device 1500, and a storage 1600, and a network interface 1700.

The processor 1100 may be a central processing unit (CPU) or a semiconductor device that performs processing on commands stored in the memory 1300 and/or the storage 1600. The memory 1300 and the storage 1600 may include various types of volatile or nonvolatile storage media. For example, the memory 1300 may include a read only memory (ROM) 1310 and a random access memory (RAM) 1320.

Accordingly, steps of a method or algorithm described in connection with the exemplary embodiments disclosed herein may be directly implemented by hardware, a software module, or a combination of the two, executed by the processor 1100. The software module may reside in a storage medium (i.e., the memory 1300 and/or the storage 1600) such as a RAM memory, a flash memory, a ROM memory, an EPROM memory, a EEPROM memory, a register, a hard disk, a removable disk, and a CD-ROM.

An exemplary storage medium is coupled to the processor 1100, which can read information from and write information to the storage medium. Alternatively, the storage medium may be integrated with the processor 1100. The processor and the storage medium may reside within an application specific integrated circuit (ASIC). The ASIC may reside within a user terminal. Alternatively, the processor and the storage medium may reside as separate components within the user terminal.

The above description is merely illustrative of the technical idea of the present disclosure, and those skilled in the art to which the present disclosure pertain may make various modifications and variations without departing from the essential characteristics of the present disclosure.

Therefore, the exemplary embodiments disclosed in the present disclosure are not intended to limit the technical ideas of the present disclosure, but to explain them, and the scope of the technical ideas of the present disclosure is not limited by these exemplary embodiments. The protection range of the present disclosure should be interpreted by the claims below, and all technical ideas within the equivalent range should be interpreted as being included in the scope of the present disclosure.

What is claimed is:

1. An autonomous vehicle comprising:
an autonomous driving control apparatus comprising:
a communication device configured to communicate with a control system; and
a processor configured to:
automatically determine whether door opening or closing and re-start are required in a situation that an occupant gets on or off the autonomous vehicle, and
request remote control to the control system through the communication device when an operation depending on an automatic determination result thereof is impossible or the automatic determination is impossible.

2. The autonomous vehicle of claim 1, wherein the processor is further configured to determine whether a door needs to be opened based on surrounding situation information when the autonomous vehicle arrives at a stop.

3. The autonomous vehicle of claim 1, wherein the processor is further configured to determine whether a door needs to be closed when an occupant completely gets on or off the autonomous vehicle after a door of the autonomous vehicle is opened based on vehicle interior information.

4. The autonomous vehicle of claim 1, wherein the processor is further configured to determine whether the autonomous vehicle needs to be re-started when an occupant is seated based on vehicle interior information of the autonomous vehicle after a door of the autonomous vehicle is closed.

5. The autonomous vehicle of claim 1, wherein the processor is further configured to request remote control for door opening to the control system when a state in which it is impossible to perform the door opening continues for more than a predetermined time or a state in which it is impossible to determine whether a door opening control is possible continues for more than a predetermined time in a situation where the autonomous vehicle stops at a stop and the door needs to be opened.

6. The autonomous vehicle of claim 1, wherein the processor is further configured to request remote control for door closing to the control system when a state in which it is impossible to perform the door closing continues for more than a predetermined time or a state in which it is impossible to determine whether a door closing control is possible continues for more than a predetermined time in a situation where the autonomous vehicle stops at a stop, the door is opened, and then the door needs to be closed.

7. The autonomous vehicle of claim 1, wherein the processor is further configured to request remote control for re-start to the control system when a state in which it is impossible to perform the re-start continues for more than a predetermined time or a state in which it is impossible to determine whether the re-starting control is possible continues for more than a predetermined time in a situation where the autonomous vehicle stops at a stop and requires the re-start after an occupant completes getting on or off and the door is closed.

8. The autonomous vehicle of claim 1, wherein the processor is further configured to transmit vehicle interior image data and interior audio data to the control system when a door opening remote control request is required because a situation in which an occupant or a good exists within the autonomous vehicle continues or in the case where the door opening remote control request is required when door jamming is detected during door opening control.

9. The autonomous vehicle of claim 1, wherein the processor is further configured to transmit vehicle exterior image data and exterior object detection information to the control system when a situation where there is an obstacle in a space between a door and a stop of the autonomous vehicle continues and a door opening remote control request is required or when a situation where a moving object approaches the space between the door and the stop of the autonomous vehicle continues and the door opening remote control request is required.

10. The autonomous vehicle of claim 1, wherein the processor is further configured to transmit fault information and fault related video data to the control system when a remote control request is required because a situation in which information necessary for determining at least one of door opening, door closing, and re-start is not received continues for more than a predetermined time.

11. The autonomous vehicle of claim 1, wherein the processor is further configured to transmit vehicle interior image data, vehicle exterior image data, and stop image data to the control system when a remote control request is required because it is impossible to determine at least one of door opening, door closing, and re-start due to unknown causes, or a standby state lasts for more than a predetermined time.

12. The autonomous vehicle of claim 1, wherein the processor is further configured to transmit vehicle exterior image data and stop image data to the control system when a remote control request is performed in the case where a state in which it is determined that there is an occupant trying to get on it around a door outside the autonomous vehicle continues for more than a predetermined time.

13. The autonomous vehicle of claim 1, wherein the processor is further configured to transmit vehicle interior image data and interior audio data to the control system when a remote control request is performed in the case where a situation in which a standing occupant moves or does not hold a handle in an interior of the autonomous vehicle continues for more than a predetermined time.

14. The autonomous vehicle of claim 1, wherein the processor is further configured to transmit at least one of exterior image data in a direction toward a second vehicle or object, object detection information, or information related to the second vehicle to the control system when a situation where re-start is impossible due to interference from the second vehicle or object continues for more than a predetermined time.

15. A control system comprising:
a communication device configured to communicate with an autonomous vehicle; and
a processor configured to transmit a remote control command to the autonomous vehicle based on information received from the autonomous vehicle when a remote control request of at least one of door opening, door closing, and re-start is received from the autonomous vehicle through the communication device.

16. The control system of claim 15, wherein the processor is further configured to process a plurality of remote control requests in a chronological order or depending on a predetermined priority when the remote control requests are received from the autonomous vehicle.

17. The control system of claim 16, wherein the processor is further configured to preferentially process a remote control request related to a safety accident, a remote control request by a vehicle that prevents re-start of another vehicle, a remote control request due to failure or unknown cause.

18. The control system of claim 15, further comprising:
a stop monitoring device configured to acquire stop surrounding image data and to provide it to the control system.

19. A remote control method of an autonomous vehicle, the method comprising:
automatically determining whether door opening or closing and re-start are required in a situation that an occupant gets on or off the autonomous vehicle; and
requesting remote control to a control system when an operation depending on an automatic determination result thereof is impossible or the automatic determination is impossible.

20. The remote control method of claim 19, wherein the automatically determining comprises:
determining whether a door needs to be opened based on surrounding situation information when the autonomous vehicle arrives at a stop;
determining whether the door needs to be closed when an occupant completely gets on or off the autonomous vehicle after the door of the autonomous vehicle is opened based on vehicle interior information; and
determining whether the autonomous vehicle needs to be re-started when an occupant is seated based on vehicle interior information of the autonomous vehicle after the door of the autonomous vehicle is closed.
